(19) United States
(12) Patent Application Publication
(10) Pub. No.: US 2005/0017164 A1
(43) Pub. Date: Jan. 27, 2005

(54) Liquid Chromatograph mass spectrometer

(75) Inventor: Kazuo Mukaibatake, Kyoto-shi (JP)

Correspondence Address: HAUPTMAN KANESAKA BERNER PATENT AGENTS, SUITE 300, 1700 DIAGONAL RD, ALEXANDRIA, VA, 22314-2848, US

(73) Assignee: Shimadzu Corporation

(21) Appl. No.: 09/960,747

(22) Filed: Sep. 24, 2001

(30) Foreign Application Priority Data
Apr. 10, 2000 (JP) 2000-304380

(51) Int. Cl. H01J 49/00

(52) U.S. Cl. 250/288

(57) ABSTRACT

In a liquid chromatograph mass spectrometer, a liquid sample supplied from an LC portion is nebulized in an ionization chamber, and the produced nebulized sample is ionized by applying a high voltage thereto and is introduced into a mass spectrometry chamber. A supply flow path of a nitrogen gas and an oxygen gas is connected to the ionization chamber, and a control mechanism for controlling a composition ratio of the nitrogen gas and the oxygen gas in the ionization chamber is provided to thereby ionize at an optimum gas composition ratio.

### BACKGROUND OF THE INVENTION AND RELATED ART STATEMENT

The invention relates to a liquid chromatograph mass spectrometer (hereinafter referred to as “LC/MS”), in particular, an LC/MS interface disposed between a liquid chromatograph portion (hereinafter referred to as “LC portion”) and a mass spectrometry portion (hereinafter referred to as “MS portion”) of LC/MS for ionizing a liquid sample supplied from the LC portion and introducing into the MS portion.

Generally, the LC/MS includes an LC portion wherein respective components of a sample are separated and eluted; an LC/MS interface portion for ionizing the sample components eluted from the LC portion in an ionization chamber; and an MS portion for detecting the sample ionized in the LC/MS interface portion. Among them, with respect to the LC/MS interface portion, while various ionization methods for ionizing a liquid sample have been considered, recently, an atmospheric pressure ionization method to ionize by nebulizing the sample under the atmospheric pressure, such as an atmospheric pressure chemical ionization (APCI) method and an electrospray ionization (ESI) method, has been widely used.

FIG. 3 is a block diagram showing a structure of an example of the LC/MS, wherein an ESI method, one of the atmospheric pressure ionization methods, is used. In the apparatus, an ionization chamber 11 functioning as the LC/MS interface portion, a first intermediate chamber 12 adjacent to the ionization chamber, a second intermediate chamber 13 adjacent to the first intermediate chamber and a mass spectrometry portion 14 adjacent to the second intermediate chamber, are provided through partitions, respectively.

The sample separated to components at the LC portion is supplied through a flow path 155 for supplying the sample. Also, a nebulized gas, i.e. nitrogen gas, is supplied through a nitrogen gas flow meter 157 and a flow path 156 for supplying the nebulized gas from a nitrogen cylinder 158. Then, the sample and the nebulized gas are introduced into a spray 15 to be nebulized into the ionization chamber 11.

Incidentally, although the nitrogen gas is most popular as the nebulized gas, under a negative mode, i.e. in case of analyzing mass of negative ion, as a substitution of the nitrogen gas, a synthesized air, i.e. artificially produced gas having a composition ratio of oxygen and nitrogen similar to that of real air, or a gas of 100% oxygen may be used. This is because in case a high voltage necessary for ionization is applied, when oxygen is used, it is possible to hold a high discharge breakdown voltage.

A detailed structure of the ionization chamber 11 is shown in FIG. 4. A chamber 35 for constituting an outer wall surface of the apparatus is formed by a wall surface to which the spray 15 is attached and a wall surface to which a shutter 26 is attached, which are arranged to have a right angle. A bent solvent removing tube 19 is attached to a partition wall 36 for separating the ionization chamber 11 and the first intermediate chamber 12, and a heater block 20 having therein a temperature control mechanism, not shown, is fixed to the partition wall 36. The solvent removing tube 19 is heated by the heater block 20. An inlet 191 of the solvent removing tube 19 is oriented substantially at a right angle to the sample nebulized and ejected from the spray 15 to thereby prevent a giant sample liquid-drop from entering the solvent removing tube 19. Also, a shutter 26 is positioned on an extended line of the inlet 191 of the solvent removing tube 19, so that the inlet 191 is opened or closed by a stretching movement of rubber 261 attached to a forward end of the shutter 26 by a driving mechanism, not shown. A drain 30 is formed ahead in the nebulizing direction of the spray 15 so that unnecessary nebulized sample is discharged therethrough.

FIG. 5 is an enlarged view showing a forward end portion of the spray 15. The spray 15 has a double tube structure wherein the sample supplied through the flow path 155 is nebulized from an inner side 154 (inner tube) of the tube 151. On the other hand, the nebulized gas, i.e. nitrogen gas, supplied from the flow path 156 is nebulized from a space, i.e. outer tube 153 between the tube 151 and a tapered nozzle 152. Thus, the nebulized liquid sample collides with the nebulized gas nebulized therearound to be a nebulized state.

In the ESI method, a wiring for applying a high voltage of several kilovolts from a voltage source, not shown, is connected to a forward end of the nozzle 152 to thereby ionize.

In the APCI method, a needle electrode is separately provided to the forward end of the nozzle, and a high voltage is applied to the needle electrode to thereby generate corona discharge. With the corona discharge, a carrier gas ion is subjected to a chemical reaction to ionize.

The ionization chamber 11 and the first intermediate chamber 12 are communicated with each other through the solvent removing tube 19 as described before. The solvent removing tube 19 has such a function that when the ions and fine droplets nebulized by the spray 15 pass through the tube, solvent removal and ionization are promoted through heating action and colliding action.

Again, with reference to FIG. 3, the chambers after the first intermediate chamber 12 will be explained. The first intermediate chamber 12 is provided with first ion lenses 21 and an exhaust port 31 for vacuum evacuation by an oil rotating pump (RP), not shown.

A skimmer 22 having an orifice is formed on a partition disposed between the first intermediate chamber 12 and the second intermediate chamber 13, and the two chambers are communicated with each other through the orifice.

The second vacuum chamber 13 is provided with octopoles 23, a focus lens 24 and an exhaust port 32 for vacuum evacuation by a turbo-molecular pump (TMP), not shown.

An entrance lens 25 having an orifice is provided on a partition disposed between the second intermediate chamber 13 and a mass spectrometry chamber 14, and the two chambers are communicated with each other through the orifice.

The mass spectrometry chamber 14 is provided with a first quadrupole 16, a second quadrupole 17, a detector 18 and an exhaust port 33 for vacuum evacuation by the turbo-molecular pump (TMP), not shown.

The ion lenses 21, octopoles 23, focus lens 24, entrance lens 25 have focusing actions for effectively sending out ions passing therethrough under respective vacuum conditions with respective ion speeds to the next steps, respectively. Also, the quadrupoles 16 and 17 having a double structure disposed in the mass spectrometry chamber 14 have a high performance mass separation action.

In such an apparatus, ions produced in the ionization chamber 11 are sent to the mass spectrometry chamber 14 through the solvent removing tube 19, the first intermediate chamber 12, the first ion lenses 21, the skimmer 22, the second intermediate chamber 13, the octopoles 23, the focus lens 24 and the entrance lens 25, in order; the unnecessary ions are discharged by the quadrupoles 16, 17; and only specific ions which arrive at the detector 18 are detected.

In order to carry out a sensitive measurement by the LC/MS, there are mainly following methods. First, a quantity of the sample supplied from the LC portion is increased as much as possible to elevate the signal intensity. Second, in order to carry out a sensitive measurement, positions of the various focus lenses are adjusted or voltages to be applied are optimized so that the ions produced in the ionization chamber can be effectively transferred to the detector of the final stage where the high vacuum state is maintained.

The main efforts for improving the sensitivity of the conventional LC/MS are limited to the above stated points. Of course, it is important that the sensitivity must be improved by these efforts. However, if there is another effective parameter for improving the sensitivity, further highly sensitive measurement by the LC/MS can be obtained by controlling the effective parameter.

Therefore, it is an object of the present invention to provide a LC/MS capable of providing a sensitive measurement by finding out other parameters for improving the sensitivity of the LC/MS and using them.

Another object of the invention is to provide an apparatus as stated above, wherein the new parameters can be easily controlled.

Further objects and advantages of the invention will be apparent from the following description of the invention.

### SUMMARY OF THE INVENTION

In order to solve the above problems, in the present invention, in the LC/MS, a liquid sample supplied from an LC portion is nebulized by a spray in the ionization chamber, a high voltage is applied to the produced nebulized sample to ionize, and then the sample is introduced into a mass spectrometry portion. A flow path for supplying a nitrogen gas and an oxygen gas into the ionization chamber is connected to the ionization chamber, and a controlling mechanism for controlling a composition ratio of the nitrogen gas and the oxygen gas is provided.

In the LC/MS according to the present invention, the nitrogen gas and the oxygen gas can be supplied to the ionization chamber, and the composition ratio thereof can be controlled at will. Heretofore, in the LC/MS according to the atmospheric pressure ionization method, generally, the nitrogen gas as a nebulized gas is supplied to the ionization chamber. Although there has been a case where synthesis air or gas of 100% oxygen is supplied to the ionization chamber, in any case, it is not required to positively control the composition ratio of the nebulized gas. Therefore, any function for controlling the composition ratio is not provided to the LC/MS. Thus, the nebulized gas filled in a bomb or the like is generally supplied as it is.

However, while studying the parameter for elevating the analysis sensitivity, it has been confirmed that there is an atmospheric gas condition optimum for ionization, i.e. a condition of the gas composition ratio in the ionization chamber. Therefore, the atmospheric gas condition in the ionization chamber can be controlled by controlling the composition ratio of the nebulized gas, so that ionization can be carried out under the optimum atmospheric gas condition.

Also, in order to control the atmospheric gas condition in the ionization chamber, an atmospheric gas control flow path for directly introducing the gas into the ionization chamber is provided to the ionization chamber in addition to a nebulized gas supply flow path.

### BRIEF DESCRIPTION OF THE DRAWINGS

FIG. 1 is a block diagram for showing a structure of a liquid chromatograph mass spectrometer of an embodiment according to the invention;

FIG. 2 is a block diagram for showing a structure of a liquid chromatograph mass spectrometer of another embodiment according to the invention;

FIG. 3 is a block diagram for showing a structure of a conventional liquid chromatograph mass spectrometer;

FIG. 4 is a partially enlarged view of an ionization chamber;

FIG. 5 is a drawing for showing a structure of a forward end of a spray in an ESI method; and

FIGS. 6(a) and 6(b) are graphs for showing mass chromatographs when an atmospheric composition in an ionization chamber is changed.

### DETAILED DESCRIPTION OF PREFERRED EMBODIMENTS

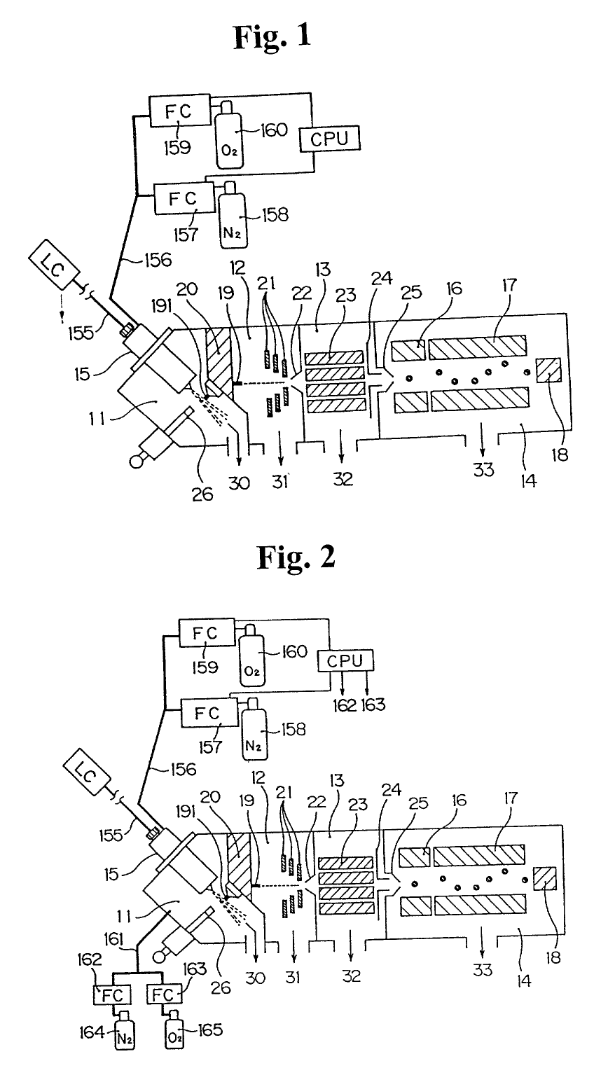

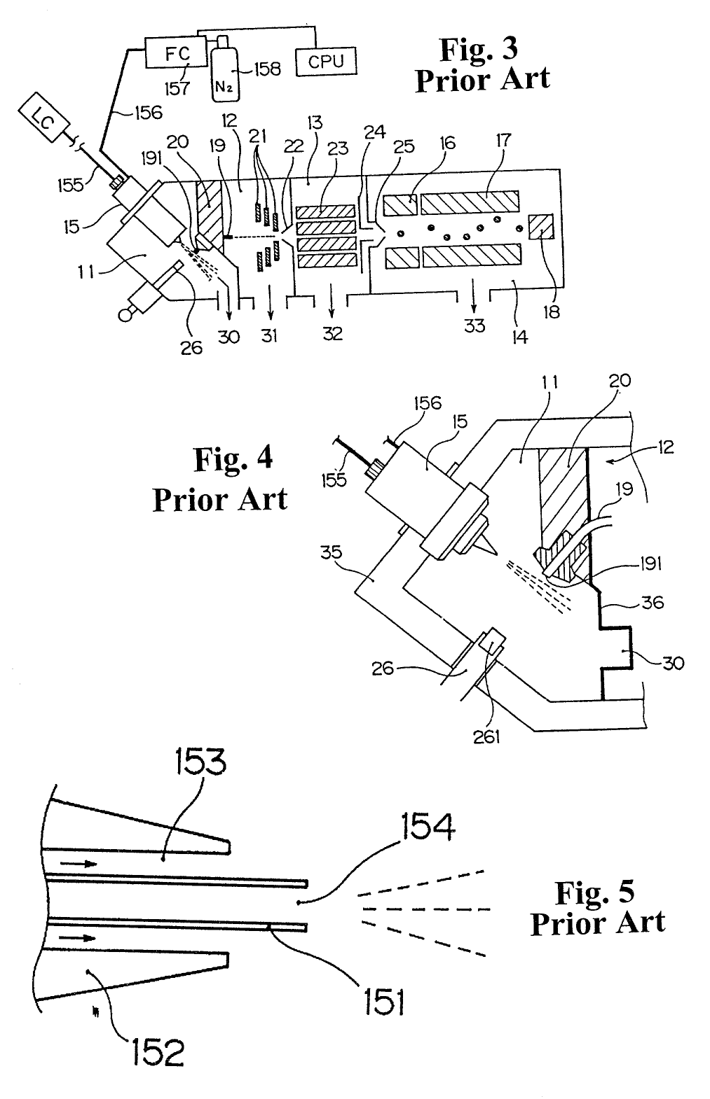

Hereunder, embodiments of the present invention will be explained with reference to the accompanying drawings. FIG. 1 is a block diagram of an LC/MS showing an embodiment according to the invention. In the drawing, reference numeral 11 represents an ionization chamber, 12 is a first intermediate chamber, 13 is a second intermediate chamber, 14 is a mass spectrometry chamber, 15 is a spray, 16 is a first quadrupole, 17 is a second quadrupole, 18 is a detector, 19 is a solvent removing tube, 20 is a heater block, 21 is an ion lens, 22 is a skimmer, 23 is an octopole, 24 is a focus lens, 25 is an inlet lens, 26 is a shutter, 30 is a drain, 31, 32, 33 are air outlets, 155 is a flow path for supplying a sample, 156 is a flow path for supplying nebulized gas, 157 is a nitrogen gas flow meter, 158 is a nitrogen gas cylinder, and 191 is an inlet of the solvent removing tube. Since the above structure is the same as that of the conventional apparatus shown in FIG. 3, the same reference numerals as those of the conventional apparatus have been assigned, and explanations therefor are omitted.

In the LC/MS of the invention, an oxygen gas cylinder 160 is further connected to a flow path 156 for supplying the nebulized gas through an oxygen gas flow meter 159.

Since the nitrogen gas flow meter 157 and the oxygen gas flow meter 159 are independently controlled, gas having a desired composition ratio can be supplied to the ionization chamber 11 as a nebulized gas by suitably controlling these flow meters.

Therefore, in case of carrying out an analysis, the nitrogen gas flow meter 157 and the oxygen gas flow meter 159 may be controlled for every sample to find out a gas composition ratio so that a signal strength detected by the detector 18 becomes the maximum.

Incidentally, in order to automatically control the nitrogen gas flow meter 157 and the oxygen gas flow meter 159, by connecting them to a central processing unit (CPU) for the whole LC/MS, the CPU may also receive a signal from the detector 18 and control the flow meters so that the ion detecting signal becomes maximum. Thus, the optimum conditions can be determined.

FIG. 2 is a block diagram of the LC/MS showing another embodiment according to the present invention. In the LC/MS of this embodiment, an atmospheric gas supply flow path 161 for supplying the atmospheric gas is attached to the ionization chamber 11 of the apparatus shown in FIG. 1 to directly supply the atmospheric gas in addition to the nebulized gas. The atmospheric gas supply flow path 161 is connected to join a flow path connected to the nitrogen gas cylinder 164 through the nitrogen gas flow meter 162 and a flow path connected to the oxygen gas cylinder 165 through the oxygen gas flow meter 163, so that a composition ratio of the atmospheric gas to be supplied to the ionization chamber 11 can be controlled. Incidentally, a wiring system may be designed to share the cylinders 164 and 158 and cylinders 165 and 160. Also, the nitrogen gas flow meter 162 and the oxygen gas flow meter 163 may be connected to the CPU for controlling the whole LC/MS to control the flow meters so that the ion detection signal becomes the maximum by receiving a signal from the detector 18. More specifically, in case of the LC/MS as shown in FIG. 2, the composition ratio is determined by the total of the nitrogen gas flow meters 157, 162 and the oxygen gas flow meters 159, 163.

Incidentally, in the above described LC/MS, although the nitrogen gas cylinder and the oxygen gas cylinder are used as gas sources, a combination, such as a synthesis air cylinder and an oxygen gas cylinder or a synthesis air and nitrogen gas cylinder, may be used.

### EXPERIMENTAL EXAMPLES

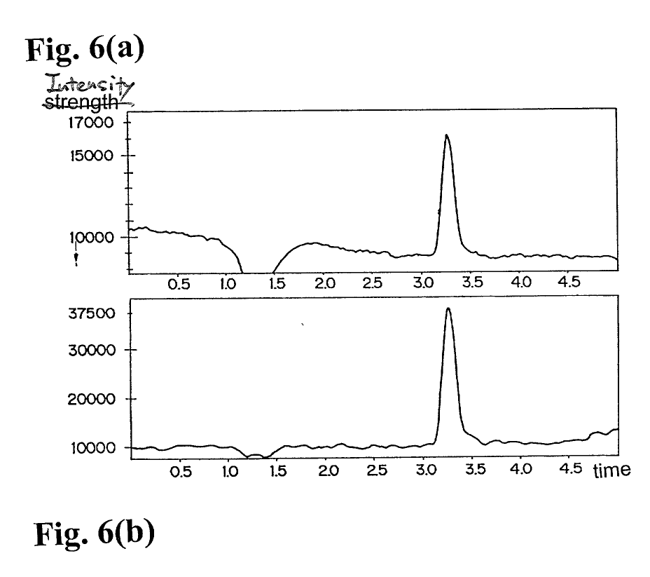

Hereunder, experimental examples according to the invention will be explained. FIGS. 6(a) and 6(b) are graphs showing variations of detection sensitivities when the flow quantities of the nebulized gas and the atmospheric gas are changed.

The common analysis conditions are as follows:

| | |
|---|---|
| Ionization mode | Atmospheric pressure chemical |
| | ionization method, negative mode |
| SIM ion | m/z 227 |
| Needle electrode | −3 KV |
| Sample | Bisphenol A |
| Moving phase | Water:methanol (65:35) |
| Used column | ODS 2.1 mm × 150 mm |
| Column oven temp. | 40° C. |
| Flow quantity | 0.3 ml/min |

Analysis conditions in FIG. 6 (a)

| | |
|---|---|
| Nebulized gas | 2.5 L/min synthesis air (N₂:O₂ 4:1) |

Analysis conditions in FIG. 6 (b)

| | |
|---|---|
| Nebulized gas | 2.5 L/min nitrogen gas |
| Atmospheric gas | 1 L/min synthesis air (N₂:O₂ 4:1) |

In FIGS. 6(a) and 6(b), an abscissa represents time, and an ordinate represents signal intensity. In FIG. 6(a), as a standard reference, only synthesis air is used as the nebulized gas. On the other hand, in FIG. 6(b), 2.5 L of the nitrogen gas as the nebulized gas is used, and the synthesis air as the atmospheric gas is supplied while its flow quantity is controlled to finally reach 1 L. Thus, the composition ratio of the nitrogen gas and the oxygen gas in the ionization chamber is optimized as N₂: O₂=33: 2.

When the heights of the signal peaks created at a time after 3.3 minutes from the beginning of the measurement in both cases are compared, as apparent from the graphs, the signal intensity, i.e. ˜27500 in FIG. 6(b), is stronger than the signal intensity, i.e. ˜7000 in FIG. 6(a), by three times. As explained above, by obtaining the optimum condition of the gas composition ratio in the ionization chamber, the signal intensity of signals to be detected can be greatly increased.

As described above, since the LC/MS according to the invention includes a mechanism for controlling the gas composition ratio in the ionization chamber, by optimizing the gas composition ratio in the ionization chamber, a measurement sensitivity can be greatly improved, and also, the measurement can be carried out under a different optimum condition for each sample. It is also possible to easily find out the optimum condition by carrying out an automatic control so that the ion detection signal becomes maximum based on the ion detection signal from the detector.

Further, in the anionization mode, especially, the APCI method, an abnormal discharge is liable to take place in the needle electrode portion of the APCI spray. However, by optimizing the composition ratio of the oxygen gas, the abnormal discharge can be suppressed. Therefore, by finding out the atmospheric gas condition for elevating the sensitivity as well as suppressing the abnormal discharge, the optimum conditions in the APCI method can be obtained.

While the invention has been explained with reference to the specific embodiments of the invention, the explanation is illustrative and the invention is limited only by the appended claims.

1. A liquid chromatograph mass spectrometer, comprising:
a liquid chromatograph portion for supplying a liquid sample,
an ionization chamber having a nebulizer connected to the liquid chromatograph portion for nebulizing the liquid sample in the ionization chamber, a produced nebulized sample being ionized by applying a high voltage thereto,
a mass spectrometry portion connected to the ionization chamber for receiving the ionized sample and analyzing the sample,
a supply flow path connected to the ionization chamber for supplying a nitrogen gas and an oxygen gas, and
a controlling mechanism connected to the supply flow path for controlling a composition ratio of the nitrogen gas and oxygen gas in the ionization chamber.

2. A liquid chromatograph mass spectrometer according to claim 1, wherein said nebulizer is formed of double tubes for a liquid sample supply flow path and a nebulized gas supply flow path.

3. A liquid chromatograph mass spectrometer according to claim 2, further comprising a nebulized gas supply section connected to the nebulized gas supply flow path for supplying a nebulized gas including a nitrogen gas and an oxygen gas.

4. A liquid chromatograph mass spectrometer according to claim 3, further comprising a control section connected to the nebulized gas supply section for controlling a composition ratio of the nitrogen gas and oxygen gas.

5. A liquid chromatograph mass spectrometer, comprising:
a liquid chromatograph portion for supplying a liquid sample,
an ionization chamber having a nebulizer connected to the liquid chromatograph portion for nebulizing the liquid sample in the ionization chamber, said atomizer being formed of double tubes for a liquid sample supply flow path and a nebulized gas supply flow path for supplying a mixture of a nitrogen gas and an oxygen gas, a produced nebulized sample being ionized by applying a high voltage thereto,
a control mechanism connected to the nebulized gas supply flow path for controlling a composition ratio of the nitrogen gas and the oxygen gas, and
a mass spectrometry portion connected to the ionization chamber for receiving the ionized sample and analyzing the sample.
